(19) United States
(12) Patent Application Publication
(10) Pub. No.: US 2024/0060675 A1
(43) Pub. Date: Feb. 22, 2024

(54) DEVICES, SYSTEMS, AND METHODS FOR REDUCING LEAKAGE CURRENT

(71) Applicant: TRANE INTERNATIONAL INC., Davidson, NC (US)

(72) Inventors: John Hughes, Flint, TX (US); Thomas Reed, Whitehouse, TX (US); David Williams, JR., Tyler, TX (US); James T. Vershaw, Tyler, TX (US)

(21) Appl. No.: 17/891,575

(22) Filed: Aug. 19, 2022

(51) Int. Cl. F24F 11/88; H02H 3/16

(52) U.S. Cl. CPC F24F 11/88; H02H 3/16; F25B 31/02

(57) ABSTRACT

Devices, systems, and methods are disclosed for reducing leakage current in compressors, such as for HVAC systems. Several embodiments include a leakage current suppressor configured to reduce passage of electrical current into the housing of a compressor via a conductive pathway between an electrical conductor and the housing. For instance, the leakage current suppressor may sufficiently reduce the passage of electrical current into the housing of a compressor to prevent tripping a GFCI. In many embodiments, the conductive pathway may be formed, at least in part, by a liquid refrigerant in the compressor housing.

### TECHNOLOGICAL FIELD

The present disclosure relates generally to improved devices, systems, and methods for reducing leakage current in heating, ventilation, and air conditioning (HVAC) compressors to facilitate compatibility with electrical circuits having a ground fault circuit interrupter (GFCI).

### BACKGROUND

Generally, HVAC systems are used to heat and/or cool building spaces. Such building spaces include single story and multi-story schools, office buildings, and manufacturing facilities, for example. A HVAC system may include a heat transfer circuit to provide cooled or heated air to an area. The heat transfer circuit is configured to heat and/or cool a process fluid (e.g., air, water and/or glycol, or the like) with a working fluid (e.g., one or more refrigerants) in a heat exchanger. The working fluid is circulated through the heat transfer circuit via a compressor that compresses the working fluid.

Recent proposed changes to codes and regulations have suggested that GFCI's should be placed on residential outdoor outlets. Combining existing GFCI devices with a typical HVAC system may result in unintended “nuisance” trips of the GFCI device, resulting in sub-optimal comfort performance. The present disclosure seeks to avoid or minimize such nuisance trips.

### BRIEF SUMMARY

The inventors have determined that the presence of liquid refrigerant in a compressor, used to compress the working fluid of the HVAC system, as opposed to gaseous refrigerant, can cause leakage current within the electrical system. In some instances, this leakage current is sufficient to trip a GFCI. In existing systems, accounting for this leakage current was less important, because GFCI switches were not typically used. By introducing a GFCI into the system, the performance of the HVAC can be negatively impacted if the GFCI is unnecessarily tripped by the presence of leakage current, where the inventors have determined that the level of leakage current is particularly high when the compressor operates in the presence of liquid refrigerant. Accordingly, one or more embodiments disclosed herein includes a leakage current suppressor configured to sufficiently reduce leakage current to prevent operation of the compressor from tripping a GFCI or other type of circuit breaker.

Devices, systems, and methods are disclosed for reducing leakage current in compressors, such as for HVAC systems. Several embodiments include a leakage current suppressor configured to reduce passage of electrical current into the housing of a compressor via a conductive pathway between an electrical conductor and the housing. For instance, the leakage current suppressor may sufficiently reduce the passage of electrical current into the housing of a compressor to prevent tripping a GFCI. In many embodiments, the conductive pathway may be formed, at least in part, by a liquid refrigerant in the compressor housing.

The present disclosure thus includes, without limitation, the following example embodiments. Some example implementations provide a compressor for a heating, ventilation, and air conditioning (HVAC) unit, the compressor comprising: a housing, the housing having an interior and an exterior; a motor located within the housing; a power terminal feed-through for providing power to the motor, the power terminal feed-through configured to pass an electrical conductor from the exterior of the housing into the interior of the housing, wherein the electrical conductor comprises a portion of an electrical circuit comprising a ground fault circuit interrupter (GFCI); and a leakage current suppressor configured to reduce passage of electrical current into the housing of the compressor via a conductive pathway between the electrical conductor and the housing, wherein the conductive pathway is created, at least in part, by liquid refrigerant within the housing.

Other example implementations provide a heating, ventilation, and air conditioning (HVAC) system comprising: a refrigerant circuit configured to route a refrigerant fluid, the refrigerant fluid configured to undergo a phase change between a liquid form and a gas form; a compressor operable to circulate the refrigerant fluid through the refrigerant circuit, the compressor having a motor; and an electrical circuit configured to supply power to the compressor, the electrical circuit coupled to a ground fault circuit interrupter (GFCI) operably connected between a power source and the compressor, wherein a leakage current at the compressor is limited such that the electrical circuit supplies current to the compressor below a trip threshold of the GFCI with, at least a portion of, the refrigerant fluid in a liquid form within the compressor.

Still other implementations provide a method comprising: monitoring a proximate temperature; monitoring a remote temperature; detecting a first threshold temperature difference between the proximate temperature and the remote temperature; in response to detection of the first threshold temperature difference, disconnecting the compressor from power via a two-pole contactor and turning on a compressor heater; detecting a second threshold temperature difference between the proximate temperature and the remote temperature; and in response to detection of the second threshold temperature difference, reconnecting the compressor to power via the two-pole contactor and turning off the compressor heater.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise.

### BRIEF DESCRIPTION OF THE SEVERAL VIEWS OF THE DRAWINGS

For a detailed description of various exemplary embodiments, reference will now be made to the accompanying drawings in which:

FIG. 1 illustrates certain aspects of an HVAC system, according to some example implementations of the present disclosure.

FIG. 2 illustrates various aspects of an HVAC system in accordance with one or more embodiments of the current disclosure.

FIG. 3 illustrates various aspects of a compressor with a leakage current suppressor according to one or more embodiments of the current disclosure.

FIGS. 4A and 4B illustrates various aspects of a leakage current suppressor for a thermal limit switch of a compressor according to one or more embodiments of the current disclosure.

FIG. 5 illustrates various aspects of a leakage current suppressor for a power terminal feed-through of a compressor according to one or more embodiments of the current disclosure.

FIG. 6 illustrates an exemplary compressor with a leakage current suppressor according to one or more embodiments of the current disclosure.

FIG. 7 illustrates an exemplary process flow for reducing leakage current according to one or more embodiments of the current disclosure.

FIG. 8 is an illustration of control circuitry, according to an example embodiment of the present disclosure.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. Further, when used herein (including in the claims), the words “about,” “generally,” “substantially,” “approximately,” and the like mean within a range of plus or minus 10% unless otherwise stated herein.

Generally, HVAC systems are used to heat and/or cool building spaces. These systems can vary in complexity, but they often include a refrigerant circuit used to transfer thermal energy into and out of a working fluid, which is typically one or more refrigerant fluids. These systems typically use a compressor to circulate the working fluid through the refrigerant circuit. As part of the thermal transfer process, the working fluid may undergo a phase change from a liquid form to a gas form and vice versa. However, in existing systems, the presence of liquid refrigerant fluid in the compressor, as opposed to gas refrigerant fluid, has been found to occasionally cause sufficient leakage current within a compressor to trip a GFCI. Thus, existing systems may fail to reliably or properly operate when the compressor is connected to an electrical circuit with a GFCI.

Accordingly, one or more embodiments disclosed herein include a leakage current suppressor configured to sufficiently reduce leakage current to prevent operation of the compressor from tripping a GFCI. Due to the higher conductivity of liquid refrigerant compared to gaseous refrigerant, many embodiments disclosed herein are advantageously directed to preventing liquid refrigerant from contacting components of a compressor and/or removing liquid refrigerant from the compressor to reduce passage of electrical current into a housing of the compressor via a conductive pathway at least partially formed by the liquid refrigerant. Thus, the devices, systems, and methods disclosed hereby can improve compatibility and/or usability of HVAC systems when combined with GFCIs.

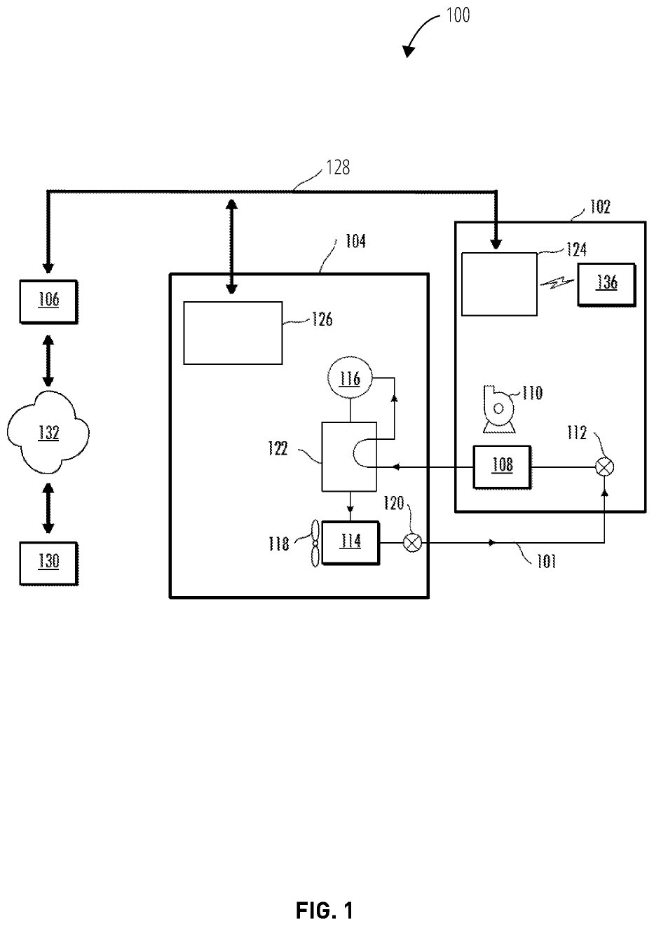

For context FIG. 1 is shown to provide an overview an HVAC system generally. FIG. 1 shows a schematic diagram of a typical HVAC system 100. In some embodiments, the HVAC system 100 comprises a heat pump system that may be selectively operated to implement one or more substantially closed thermodynamic refrigerant cycles to provide a cooling functionality (hereinafter a “cooling mode”) and/or a heating functionality (hereinafter a “heating mode”). At least one embodiment may include a system with only a cooling function or only a heating function. The embodiments depicted in FIG. 1 is configured in a cooling mode. The HVAC system 100, in some embodiments is configured as a split system heat pump system, and generally comprises an indoor unit 102, an outdoor unit 104, and a system controller 106 that may generally control operation of the indoor unit 102 and/or the outdoor unit 104.

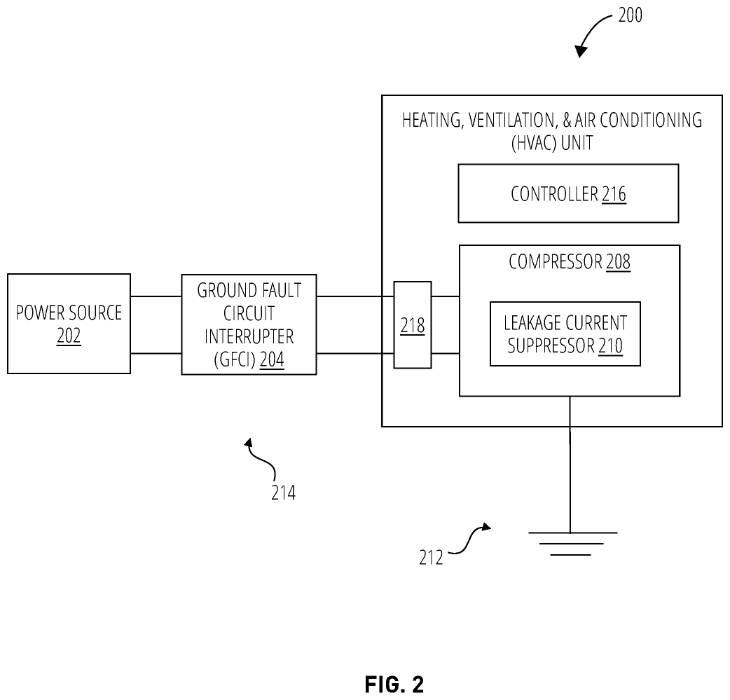

FIG. 1 may include one or more components that are the same or similar to one or more other components of the present disclosure. Further, one or more components of FIG. 1, or aspects thereof, may be incorporated into, or excluded from, various embodiments of the present disclosure without departing from the scope of this disclosure. For example, one or more components of outdoor unit 104 and/or one or more components of indoor unit 102 may be incorporated into one or more of the embodiments of FIGS. 2-6 without departing from the scope of this disclosure.

Indoor unit 102 generally comprises an indoor air handling unit comprising an indoor heat exchanger 108, an indoor fan 110, an indoor metering device 112, and an indoor controller 124. The indoor heat exchanger 108 may generally be configured to promote heat exchange between a refrigerant carried within internal tubing of the indoor heat exchanger 108 and an airflow that may contact the indoor heat exchanger 108 but that is segregated from the refrigerant.

The indoor metering device 112 may generally comprise an electronically-controlled motor-driven electronic expansion valve (EEV). In some embodiments, however, the indoor metering device 112 may comprise a thermostatic expansion valve, a capillary tube assembly, and/or any other suitable metering device.

Outdoor unit 104 generally comprises an outdoor heat exchanger 114, a compressor 116, an outdoor fan 118, an outdoor metering device 120, a switch over valve 122, and an outdoor controller 126. The outdoor heat exchanger 114 may generally be configured to promote heat transfer between a refrigerant carried within internal tubing of the outdoor heat exchanger 114 and an airflow that contacts the outdoor heat exchanger 114 but is segregated from the refrigerant. In some embodiments, the outdoor metering device 120 and/or switch over valve 122 may be optional. For example, heat pumps may include an outdoor metering device and a switch over valve, but air conditioners may not. In various embodiments, the outdoor controller 126 may be optional. For example, systems that do not include a heat pump and/or variable speed air conditioner may not include an outdoor controller.

The outdoor metering device 120 may generally comprise a thermostatic expansion valve. In some examples, however, the outdoor metering device 120 may comprise an electronically-controlled motor driven EEV similar to indoor metering device 112, a capillary tube assembly, and/or any other suitable metering device.

In some examples, the switch over valve 122 may generally comprise a four-way reversing valve. The switch over valve 122 may also comprise an electrical solenoid, relay, and/or other device configured to selectively move a component of the switch over valve 122 between operational positions to alter the flow path of refrigerant through the switch over valve 122 and consequently the HVAC system 100.

The system controller 106 may generally be configured to selectively communicate with the indoor controller 124 of the indoor unit 102, the outdoor controller 126 of the outdoor unit 104, and/or other components of the HVAC system 100. In some embodiments, the system controller 106 may be configured to control operation of the indoor unit 102, and/or the outdoor unit 104. In some embodiments, the system controller 106 may be configured to monitor and/or communicate with a plurality of temperature sensors associated with components of the indoor unit 102, the outdoor unit 104, and/or the outdoor ambient temperature.

In some examples, the system controller 106 may be configured for selective bidirectional communication over a communication bus 128. In some examples, the system controller 106 may be configured to selectively communicate with components of the HVAC system 100 and/or any other device 130 via a communication network 132.

The indoor controller 124 may be carried by the indoor unit 102 and may generally be configured to receive information inputs, transmit information outputs, and/or otherwise communicate with the system controller 106, the outdoor controller 126, and/or any other device 130 via the communication bus 128 and/or any other suitable medium of communication. In some embodiments, the indoor controller 124 may be included in the thermostat.

The indoor EEV controller 136 may be configured to receive information regarding temperatures and/or pressures of the refrigerant in the indoor unit 102. More specifically, the indoor EEV controller 136 may be configured to receive information regarding temperatures and pressures of refrigerant entering, exiting, and/or within the indoor heat exchanger 108.

The outdoor controller 126 may be carried by the outdoor unit 104 and may be configured to receive information inputs, transmit information outputs, and/or otherwise communicate with the system controller 106, the indoor controller 124, and/or any other device 130 via the communication bus 128 and/or any other suitable medium of communication. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116.

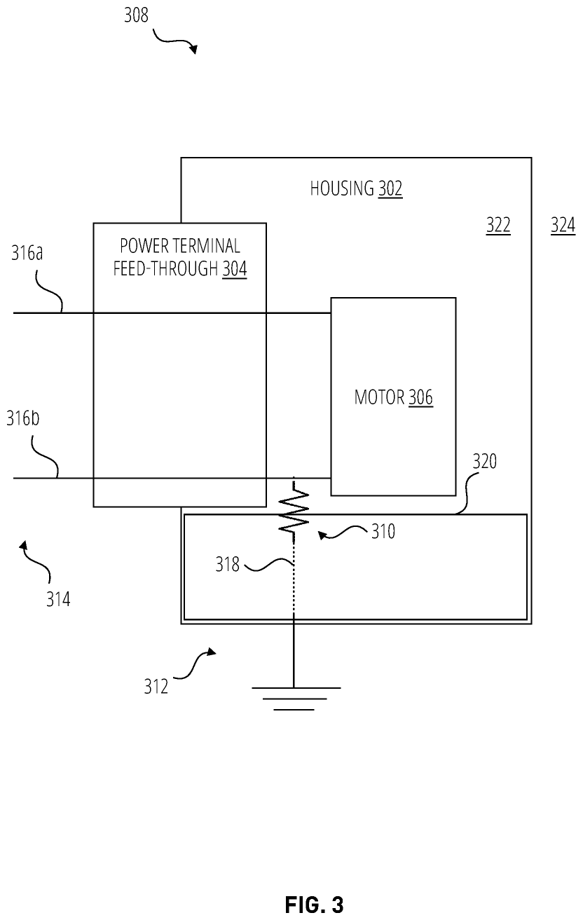

FIG. 2 illustrates an example electrical pathway that may be used by an HVAC unit 200. In the depicted example an HVAC unit 200 coupled to a power source. FIG. 2 includes the HVAC unit 200 in conjunction with a power source 202 and a GFCI 204. The HVAC unit 200 includes a compressor 208, a controller 216, and a contactor 218 with a leakage current suppressor 210 and the compressor 208 is connected to an electrical ground 212. The compressor 208 includes a leakage current suppressor 210, and in the depicted example the compressor 208 is connected to an electrical ground 212. In the illustrated embodiment, the power source 202, GFCI 204, compressor 208, and contactor 218 may form at least a portion of an electrical circuit 214. In some embodiments, FIG. 2 may include one or more components that are the same or similar to one or more other components of the present disclosure. For example, HVAC unit 200 may be the same or similar to HVAC system 100. In another example, controller 216 may be the same or similar to outdoor controller 126. In yet another example, the HVAC unit 200 may be the same or similar to the outdoor unit 104 of HVAC system 100. Further, one or more components of FIG. 2, or aspects thereof, may be incorporated into, or excluded from, various embodiments of the present disclosure without departing from the scope of this disclosure. For example, power source 202, GFCI 204, controller 216, contactor 218 and/or one or more additional components of HVAC unit 200 may be incorporated into the embodiments of FIG. 3, 4A, 4B, 5, or 6 without departing from the scope of this disclosure.

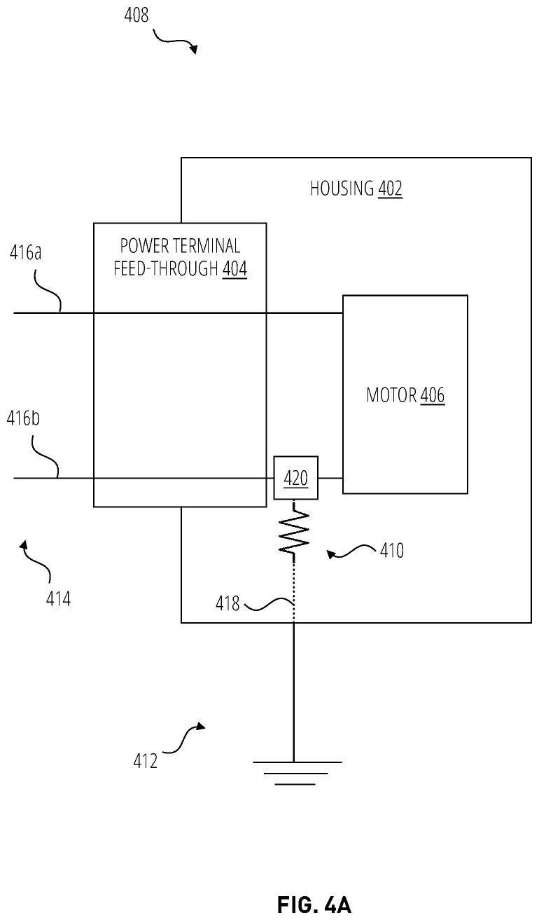

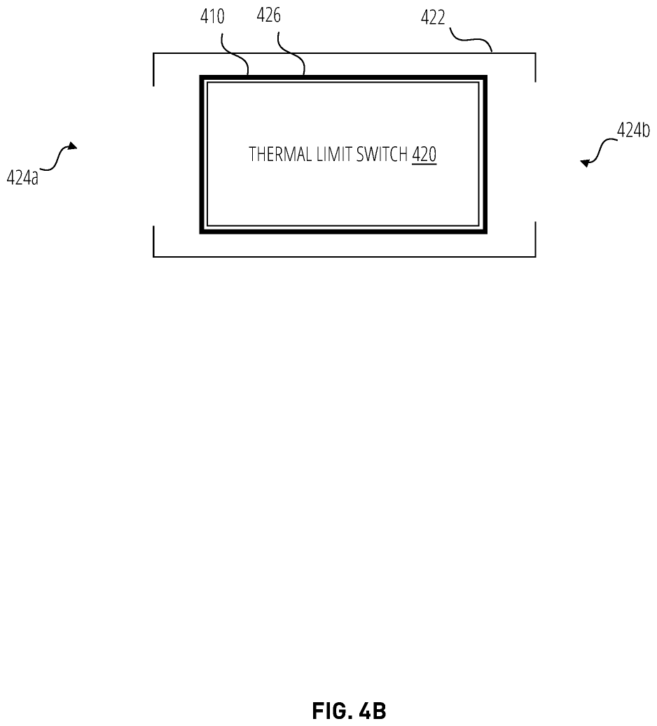

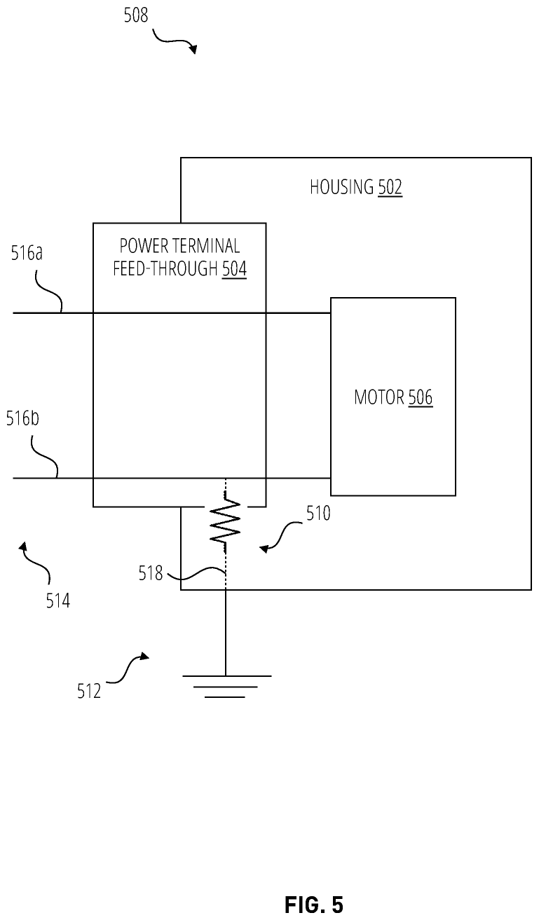

In various embodiments, the controller 216 may operate the contactor 218 to connect and disconnect the compressor 208 from the power source 202, e.g., to turn the compressor on and off during operation of the HVAC system 200. Similarly, the GFCI 204 may operate to connect and disconnect the compressor 208 from the power source 202. However, the GFCI 204 may primarily operate to disconnect the compressor 208 from the power source 202 (e.g., to trip) in response to a current imbalance in the electrical circuit 214. It will be appreciated that some embodiments disclosed hereby may not include a contactor and/or a controller. For example, the embodiments of FIGS. 4 and 5 may not include a contactor and/or a controller. The controller 216 may be powered from the indoor unit.

The GFCI 204, is an electrical safety device that breaks an electrical circuit with leakage current to ground. GFCIs can protect equipment and reduce the risk of serious harm from an ongoing electric shock. GFCIs are designed to isolate a circuit quickly and automatically when it detects that the electric current is unbalanced between the supply and return conductors of a circuit. Any difference between the currents in these conductors indicates leakage current, which presents a shock hazard. For instance, alternating 60 Hertz (Hz) current above 20 milliamps (mA) through the human body is potentially sufficient to cause cardiac arrest or serious harm if it persists for more than a small fraction of a second. Accordingly, GFCIs are designed to disconnect the conducting wires quickly enough to prevent serious injury to humans and damage to electrical devices. In some embodiments, the GFCI may be replaced with, or include, a residual-current device (RCD) or a residual-current circuit breaker (RCCB). In one embodiment, the trip threshold may differentiate an RCD and a GFCI. For example, an RCD may have a trip threshold of 20 milliamps and a GFCI may have a trip threshold between 4 and 6 milliamps. In some such embodiments, the trip thresholds may assume an alternating current of 60 Hz.

In some embodiments, the GFCI 204 may monitor the flow of power on a supply conductor and a return conductor of the electrical circuit 214, and, when the flow on the return conductor is more than a threshold difference from the flow on the supply conductor, disconnect the compressor 208 from the power source 102. A current imbalance in the electrical circuit 214 can result from a leakage current. For example, the inventors have identified that a leakage current can flow from compressor 208 to ground 212 instead of on the return leg of the electrical circuit 214, which may cause the GFCI 204 to trip. In many embodiments, the leakage current suppressor 210 is configured to reduce the passage of electrical current from the electrical circuit 214 to a housing of the compressor 208 and into the ground 212 to below a trip threshold of the GFCI 204. For example, the leakage current suppressor 210 can be configured to reduce the passage of electrical current from the electrical circuit 214 to a housing of the compressor 208 and into the ground 212 to less than 3.5 milliamps. In various embodiment, the maximum leakage current allowed by a current suppressor disclosed hereby may be configured based on the trip threshold of the circuit protection device for a specific application. For instance, Underwriters' Laboratories® standards set the GFCI threshold at 4-6 mA at 60 Hz. In one instance, 3.9 mA was measured for 0.25 seconds before the GFCI tripped. Accordingly, leakage current may be maintained below 3.5 mA or 4 mA. In many embodiments, the leakage current may be maintained at a safety margin below the trip threshold. For example, with a trip threshold of 4 mA, a safety margin of 1 mA would result in a maximum leakage current of 3 mA and a safety margin of 0.5 mA would result in a maximum leakage current of 3.5 mA.

In some examples, this reduction of leak current by the leakage current suppressor 210 is sufficient to reduce (or eliminate) trips by the GFCI 204. For example, the leakage current suppressor 210 may reduce the total leakage current of the compressor to below a trip threshold of the GFCI with, at least a portion of, the refrigerant fluid in a liquid form within the compressor. The trip level may be based on a current level specified for the GFCI, e.g., the level of current at which a given GFCI trips. In these examples, the electrical circuit supplied to the compressor with, at least a portion of, the refrigerant fluid in a liquid form within the compressor would trip the GFCI if the leakage current is not suppressed by the leakage current suppressor 210.

In some embodiments, the HVAC unit 200 may be a residential, a commercial, or industrial unit. In several embodiments, the HVAC unit 200 may comprise exemplary portions of an outdoor unit of an HVAC system. In various embodiments, the power source 202 may supply an alternating current (AC) to the electrical circuit 214. In one embodiment, the power source 202 may include a power distribution panel, such as a breaker box that is connected to a power supply (e.g., utility grid, generator, battery, and the like). In another embodiment, the power source 202 may include another portion of an HVAC system, such as the indoor unit 104 of the HVAC system 100. The compressor 208 may be the same or similar as compressor 116 discussed above. Indeed, compressor 208 may be any compressor type including a rotary compressor, a scroll compressor, a screw compressor, etc. In some examples, the compressor further includes a sump pump (not shown). In at least one embodiment, the HVAC unit 200 may include an accumulator to reduce the likelihood of liquid refrigerant entering the compressor 208.

FIG. 3 illustrates various aspects of a compressor 308 with a leakage current suppressor 310 according to one or more embodiments described hereby. In the illustrated embodiment, compressor 308 includes a housing 302, a power terminal feed-through 304, a motor 306, a leakage current suppressor 310, at least a portion of a supply conductor 316a, and at least a portion of a return conductor 316b. The housing 302 includes an interior 322 and an exterior 324. The interior 322 includes one or more motor(s) 306 and liquid refrigerant 320. The motor(s) 306 are powered via an electrical circuit 314 comprising supply conductor 316a and return conductor 316b. The supply and return conductors 316a, 316b pass from the exterior 324 of the housing 302 to the interior 322 of the housing 302 via the power terminal feed-through 304. Additionally, the housing 302 is connected to an electrical ground 312. In some embodiments, FIG. 3 may include one or more components that are the same or similar to one or more other components of the present disclosure. For example, electrical circuit 314 may be the same or similar to electrical circuit 214. Further, one or more components of FIG. 3, or aspects thereof, may be incorporated into, or excluded from, various embodiments of the present disclosure without departing from the scope of this disclosure.

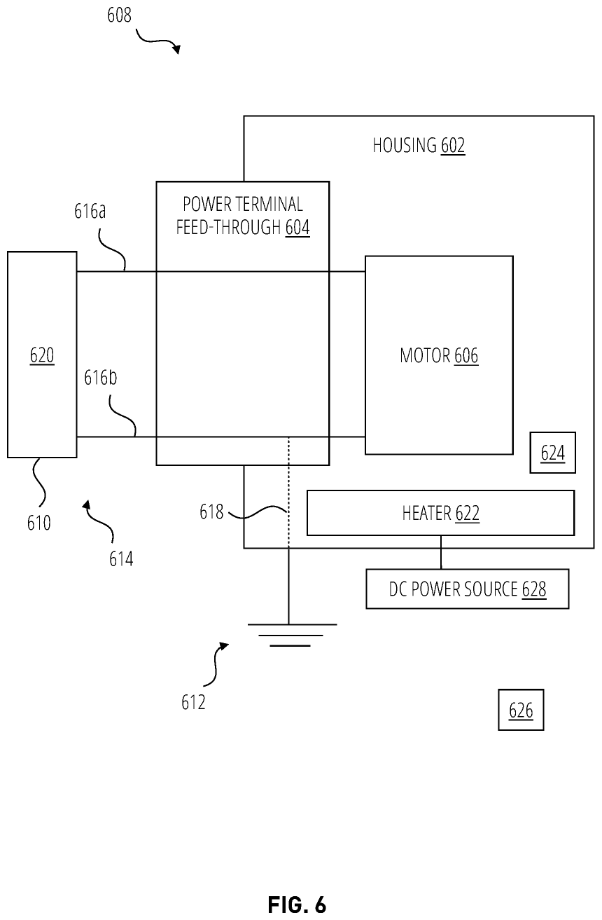

In many embodiments described hereby, the leakage current suppressor 310 may operate to reduce the flow of electrical current from the electrical circuit 314 to the housing 302 and into the ground 312 via a conductive pathway 318 at least partially formed by the liquid refrigerant 320 within the housing 302. Although illustrated on the interior 322 of housing 302, the leakage current suppressor 310 may be located on the interior 322 and/or exterior 324 of the housing 302. More generally, the leakage current suppressor 310 may increase the electrical resistance of one or more conductive pathways between the electrical circuit 314 and the ground 312. In some embodiments, the electrical resistance may be increased by insulating or isolating components from the liquid refrigerant 320 (see e.g., FIGS. 4A-5). In alternative, or additional, embodiments, the electrical resistance may be increased by removing the liquid refrigerant 320 from the interior 322 of the housing 302 (see e.g., FIG. 6).

FIGS. 4A and 4B illustrates various aspects of a leakage current suppressor 410 for a thermal limit switch 420 of a compressor 408 according to one or more embodiments of the current disclosure. The compressor 408 includes a housing 402, a power terminal feed-through 404, a motor 406, the leakage current suppressor 410, at least a portion of a first conductor 416a, at least a portion of a second conductor 416b, and the thermal limit switch 420. The interior of the housing 402 includes the motor 406 and the thermal limit switch 420. The motor(s) 406 are powered via an electrical circuit 414 comprising the first and second conductors 416a, 416b. The first and second conductors 416a, 416b pass from the exterior of the housing 402 to the interior of the housing 402 via the power terminal feed-through 404. Additionally, the housing 402 is connected to an electrical ground 412. In one or more embodiments, the leakage current suppressor 410 prevents or reduces the passage of electrical current from the thermal limit switch 420 to the housing 402 and into the ground 412. In some embodiments, FIGS. 4A and 4B may include one or more components that are the same or similar to one or more other components of the present disclosure. For example, compressor 408 may be the same or similar to compressor 116. Further, one or more components of FIGS. 4A and 4B, or aspects thereof, may be incorporated into, or excluded from, various embodiments of the present disclosure without departing from the scope of this disclosure. For example, leakage current suppressor 410 may be incorporated into compressor 308 without departing from the scope of this disclosure.

In the illustrated embodiment, leakage current suppressor 410 may form a portion of a conductive pathway 418 between the thermal limit switch 420 and the housing 402. For instance, as shown in FIG. 4B, the leakage current suppressor 410 may comprise a liquid barrier 426 applied to the thermal limit switch 420. Accordingly, the leakage current suppressor 410 may create an insulative barrier that encases the thermal limit switch 420 and prevents liquid refrigerant within the housing 402 from contacting the thermal limit switch 420. Thereby, the leakage current suppressor 410 may increase the resistance of the conductive pathway 418 between the thermal limit switch 420 and the housing 402, reducing leakage current. In many embodiments, the liquid barrier may efficiently conduct thermal energy to maintain proper functionality of the thermal limit switch 420.

Referring to FIG. 4B, the leakage current suppressor 410 may comprise the liquid barrier 426. The liquid barrier 426 may include a coating applied to the exterior, or shell, of the thermal limit switch. For instance, the coating may comprise varnish. In various embodiments, the thermal limit switch 420 may be wrapped in a nonconductive shield 422. In various such embodiments, the nonconductive shield 422 may include at least one opening configured to pass the coating through the nonconductive shield 422 to enable application of the coating to the thermal limit switch 420. For example, nonconductive shield 422 includes openings 424a and 424b to enable application of the liquid barrier 426 of current suppressor 410. In some embodiments, the at least one opening may be added to the nonconductive shield. In other embodiments, the non-conductive shield may be removed. The nonconductive shield may comprise a stretched polyester film, such as Mylar™. In some embodiments, the coating may also be applied to one or more other components of the compressor 408, such as stator windings. For instance, the at least one opening in the nonconductive shield may enable the thermal limit switch 420 to be coated with varnish at the same time the stator windings are coated with varnish.

In one embodiment, the leakage current suppressor 410 may be a liquid barrier comprising a waterproof electrical insulator. In various embodiments, the leakage current suppressor 410 may be a liquid barrier comprising one or more of a potting material and an injection molded component. For example, the thermal limit switch 420 may be potted with a potting compound. In some embodiments, the thermal limit switch 420 may be potted along with one or more other portions of the compressor, such as portions of the stator winding (e.g., the top of the stator winding). In another example, injection molding may be utilized to encase the thermal limit switch 420. In some such examples, the thermal limit switch 420 may be covered with a mold that is injected with a material (e.g., plastic or rubber). In various embodiments, one or more other portions of the compressor may be encased by the injection molding in addition to the thermal limit switch 420, such as portions of the stator winding (e.g., the top of the stator winding).

It will be appreciated that one of the first and second conductors 416a, 416b can comprise a supply conductor and the other of the first and second conductors 416a, 416b can comprise a return conductor.

FIG. 5 illustrates various aspects of a leakage current suppressor 510 for a power terminal feed-through 504 of a compressor 508 according to one or more embodiments of the current disclosure. In the illustrated embodiment, compressor 508 includes a housing 502, a power terminal feed-through 504, one or more motors 506, the leakage current suppressor 510, at least a portion of a first conductor 516a, and at least a portion of a second conductor 516b. The interior of the housing 502 includes the motor(s) 506. The motor(s) 506 are powered via an electrical circuit 514 comprising the first and second conductors 516a, 516b. The first and second conductors 516a, 516b pass from the exterior of the housing 502 to the interior of the housing 502 via the power terminal feed-through 504. Additionally, the housing 502 is connected to an electrical ground 512. In one or more embodiments, the leakage current suppressor 510 prevents or reduces the passage of electrical current from the power terminal feed-through 504 to the housing 502 and into the ground 512. In some embodiments, FIG. 5 may include one or more components that are the same or similar to one or more other components of the present disclosure. For example, housing 502 may be the same or similar to housing 402. Further, one or more components of FIG. 5, or aspects thereof, may be incorporated into, or excluded from, various embodiments of the present disclosure without departing from the scope of this disclosure. For example, leakage current suppressor 510 may be incorporated into power terminal feed-through 504 without departing from the scope of this disclosure.

In the illustrated embodiment, leakage current suppressor 510 may form a portion of a conductive pathway 518 between the power terminal feed-through 504 and the housing 502. For instance, the leakage current suppressor 510 may comprise a liquid barrier applied to the power terminal feed-through 504. In some such instances, the liquid barrier of leakage current suppressor 510 may be the same or similar to the liquid barrier 426 applied to thermal limit switch 420. Accordingly, the leakage current suppressor 510 may create an insulative barrier that prevents liquid refrigerant within the housing 502 from contacting one or more portions of the power terminal feed-through 504 (e.g., the electrical connections). Thereby, the leakage current suppressor 510 may increase the resistance of the conductive pathway 518 between the power terminal feed-through 504 and the housing 502, reducing leakage current.

In some embodiments, the leakage current suppressor 510 may be a liquid barrier comprising a waterproof electrical insulator. In various embodiments, the leakage current suppressor 510 may be a liquid barrier comprising one or more of a potting material and an injection molded component. For example, after the stator and power terminal feed-through 504 are installed in the housing 502, the electrical connection can be potted with a potting compound. In another, or additional, example, after installing in the housing 502 and connecting wiring to the stator, the power terminal feed-through 504 may be covered with a mold, which is then injected with potting compound. In various embodiments, the liquid barrier may be applied to the power terminal feed-through 504 after installation into the housing 502 due to the power terminal feed-through 504 being friction welded into position. In other embodiments, such as those in which the power terminal feed-through 504 is not friction welded in position, the power terminal feed-through 504 may be encased by injection molding prior to installation.

In many embodiments, the leakage current suppressor 510 may be a liquid barrier comprising a coating applied to one or more portions of the power terminal feed-through 504. For instance, the coating may comprise varnish. It will be appreciated that one of the first and second conductors 516a, 516b can comprise a supply conductor and the other of the first and second conductors 516a, 516b can comprise a return conductor.

FIG. 6 illustrates an exemplary compressor 608 with a leakage current suppressor 610 according to one or more embodiments of the current disclosure. FIG. 6 includes compressor 608 in conjunction with a two-pole contactor 620 and a remote temperature sensor 626. The compressor 608 includes a housing 602, a power terminal feed-through 604, a motor 606, the leakage current suppressor 610, at least a portion of a first conductor 616a, at least a portion of a second conductor 616a, a two-pole contactor 620, a heater 622, a DC power source 628, and a proximate temperature sensor 624. The interior of the housing 602 includes the motor 606. The motor 606 is powered via an electrical circuit 614 comprising the first and second conductors 616a, 616b. The first and second conductors 616a, 616b pass from the exterior of the housing 602 to the interior of the housing 602 via the power terminal feed-through 604. Additionally, the housing 602 is connected to an electrical ground 612. As will be discussed in more detail below, the leakage current suppressor 610 comprises the two-pole contactor 620. In some embodiments, FIG. 6 may include one or more components that are the same or similar to one or more other components of the present disclosure. For example, power terminal feed-through 604 may be the same or similar to power terminal feed-through 404. Further, one or more components of FIG. 6, or aspects thereof, may be incorporated into, or excluded from, various embodiments of the present disclosure without departing from the scope of this disclosure. For example, two-pole contactor 620 or heater 622 may be incorporated into compressor 308 without departing from the scope of this disclosure.

The two-pole contactor 620 may function as the leakage current suppressor 610 by preventing or reducing the passage of electrical current from the electrical circuit 614 to the housing 602 and into ground 612 by disconnecting the first and second conductors 616a, 616b from the power source (e.g., power source 202). The two-pole contactor 620 is advantageous to a single-pole contactor that opens the electrical circuit 614 by disconnecting one of the first and second conductors 616a, 616b. This is because leakage current may still flow along one of the conductors, through the housing 602, and into the ground 612 via conductive pathway 618 when one of the conductors is still connected to the power source.

In some embodiments, the proximate temperature sensor 624 may measure the temperature of the compressor and the remote temperature sensor 626 may measure the temperature remote from the compressor, such as at a coil (e.g., coil of the outside unit) or an ambient temperature. Although illustrated inside of the housing 602, the proximate temperature sensor 624 may be located external to the housing 602, but still thermally coupled to the compressor 608. Further, the proximate and remote temperatures may be measured within, or at different points of, an HVAC system (e.g., HVAC system 100). For example, the proximate temperature sensor 624 may measure the temperature of the housing 602 and the remote temperature sensor 626 may measure the ambient temperature at a controller (e.g., outdoor controller 126 or controller 216).

When the temperature of the compressor is within a temperature difference threshold of the remote temperature, there may be a high probability of liquid refrigerant being present within the compressor 608 (and therefore an increased chance of excessive leakage current). In other embodiments, a suction pressure may be monitored to determine when there is a high probability of liquid refrigerant being present within the compressor 608. For instance, a low suction pressure may be indicative of liquid refrigerant within the compressor 608.

Thus, in some embodiments, the two-pole contactor 620 may be operated (e.g., by controller 216) based on indications of liquid refrigerant in the compressor 608 (e.g., a first threshold temperature difference between proximate temperature sensor 624 and remote temperature sensor 626). In several such embodiments, when the temperature difference between the proximate and remote temperature sensors 624, 626, reaches a threshold (e.g., proximate temperature within 15 degrees of the remote temperature), the two-pole contactor 620 may be opened to completely remove line power from the compressor 608. In such embodiments, the temperature difference reaching the threshold may be indicative of compressor flooding (e.g., the presence of liquid refrigerant in the housing 602 of compressor 608). By completely disconnecting the compressor 608 from line power, the liquid refrigerant is prevented from creating a portion of a conductive pathway 618 between the electrical circuit 614 and the housing 602. Compressor flooding may be caused by low pressure cutout (e.g., insufficient indoor airflow), it may also be possible that the compressor will flood if the outdoor unit is cold soaked (e.g., no cycles overnight).

Once the temperature difference between the proximate and remote temperature sensors 624, 626 reaches a second threshold (e.g., proximate temperature is at least 15 degrees above remote temperature), the two-pole contactor 620 may be closed to reconnect the compressor 608 to line power and resume normal operation. Thus, in several embodiments, the two-pole contactor 620 may be operated (e.g., by controller 216) based on indications of the absence of liquid refrigerant in the compressor 608 (e.g., a second threshold temperature difference between proximate temperature sensor 624 and remote temperature sensor 626 or an increase in suction pressor).

Additionally, compressor 608 includes a heater 622 that can be operated, such as in conjunction with the two-pole contactor 620, based on the indications of the presence or absence of liquid refrigerant in the compressor 608 (e.g., temperature difference between proximate temperature sensor 624 and remote temperature sensor 626 or suction line pressures). The heater 622 can operate to remove liquid refrigerant from the housing 602 by heating the liquid refrigerant and/or compressor. Continuing with the previous example, when the two-pole contactor 620 is opened to completely remove line power from the compressor 608, the heater 622 may be turned on; and, when the two-pole contactor 620 is be closed to reconnect the compressor 608 to line power, the heater 622 may be turned off.

In some embodiments, the heater 622 may be configured to utilize the DC power source 628 to heat the interior of the housing. In some such embodiments, the DC power source 628 may include a low-voltage DC power source. Using DC may prevent tripping the GFCI. For instance, DC below 30 volts is generally considered safe and doesn't require protection. In one embodiment, the heater 622 may comprise a secondary winding at a run capacitor of the motor 606. In such embodiments, low-voltage DC may be provided to the secondary winding at the run capacitor of the motor 606 to heat the compressor 608. In other embodiments, the heater 622 may be located external to the housing 602, but still thermally coupled thereto. For instance, heater 622 may include a belly band heater attached to the exterior of the housing 602.

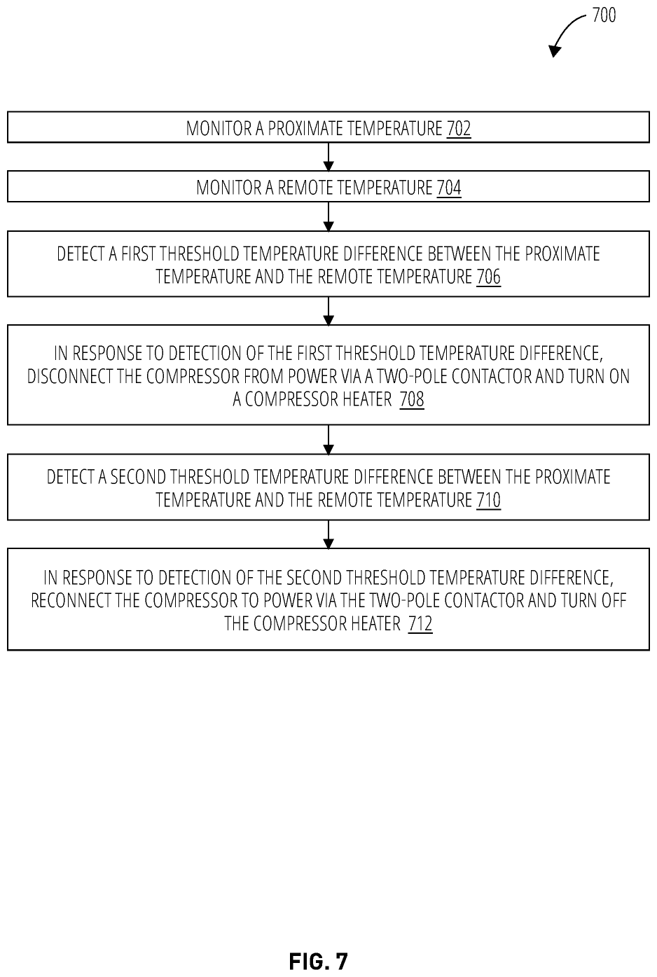

FIG. 7 illustrates one embodiment of a process flow 700 for reducing leakage current, which may be representative of operations that may be executed in various embodiments in conjunction with techniques disclosed hereby. The process flow 700 may be referred to as leakage current mitigation. The process flow 700 may be representative of some or all of the operations that may be executed by one or more components/devices/environments described hereby, such as HVAC system 100, controller 216, compressor 608, two-pole contactor 620, heater 622, proximate temperature sensor 624, or remote temperature sensor 626. The embodiments are not limited in this context.

At block 702 “monitor a proximate temperature” a proximate temperature may be monitored. For example, controller 216 may utilize proximate temperature sensor 624 to monitor the temperature proximate to the compressor 608. In some embodiments, the proximate temperature may refer to the compressor temperature. Proceeding to block 704 “monitor a remote temperature” a remote temperature may be monitored. For example, controller 216 may utilize remote temperature sensor 626 to monitor the temperature remote to the compressor 608. In some embodiments, the remote temperature may refer to a coil temperature or an ambient temperature. In one embodiment, the remote temperature may refer to the temperature of the coil in the outdoor coil.

Continuing to block 706 “detect a first threshold temperature difference between the proximate temperature and the remote temperature” a first threshold temperature difference between the proximate temperature and the remote temperature may be detected. For example, controller 216 may detect the first threshold temperature difference between the temperature measured by the proximate temperature sensor 624 and the temperature measured by the remote temperature sensor 626. In one embodiment, the first threshold temperature difference may be 15 degrees. In one such embodiment, the first threshold temperature difference may be detected when the proximate temperature is less than 15 degrees above the remote temperature. Thus, in some embodiments, the threshold temperature difference may require the proximate temperature to exceed the remote temperature by the threshold amount. In HVAC systems, the liquid refrigerant typically migrates to the lowest temperature component within the system. If the compressor is warmer than other parts, then the liquid refrigerant will migrate to other parts.

At block 708 “in response to detection of the first threshold temperature difference, disconnect the compressor from power via a two-pole contactor and turn on a compressor heater” the compressor may be disconnected from power with a two-pole contactor and a compressor heater may be turned on in response to detection of the first threshold temperature difference. For example, controller 216 may utilize two-pole contactor 620 to disconnect compressor 608 from power and controller 216 may turn on the heater 622 in response to detecting the first threshold temperature difference.

Proceeding to block 710 “detect a second threshold temperature difference between the proximate temperature and the remote temperature” a second threshold temperature difference may be detected between the proximate temperature and the remote temperature. For example, controller 216 may detect the second threshold temperature difference between the temperature measured by the proximate temperature sensor 624 and the temperature measured by the remote temperature sensor 626. In one embodiment, the second threshold temperature difference may be 15 degrees. In one such embodiment, the second threshold temperature difference may be detected when the proximate temperature is more than 15 degrees above the remote temperature.

At block 712 “in response to detection of the second threshold temperature difference, reconnect the compressor to power via a two-pole contactor and turn of the compressor heater” the compressor may be reconnected to power with the two-pole contactor and the compressor heater may be turned off in response to detection of the second threshold temperature difference. For example, controller 216 may utilize two-pole contactor 620 to reconnect compressor 608 to power and controller 216 may turn off the heater 622 in response to detecting the second threshold temperature difference.

In various embodiments, the process flow 700 may return to block 702 after block 712. In embodiments in which the system is not calling for compressor operation, then the compressor may be left disconnected from power in block 712. However, if there is an active system call for compressor operation (heat pump or cooling) then the control will energize the contactor (i.e., reconnect the compressor to power via the two-pole contactor. Additionally, in some embodiments, the compressor may already be disconnected from power at block 708, such as when there is no active system call for compressor operation. It follows that if leakage current mitigation is active or if there is no call for compressor operation, then the control will de-energize the contactor; and if there is an active call for compressor operation (heat pump or cooling) and leakage current mitigation is not active, then the control will energize the contactor.

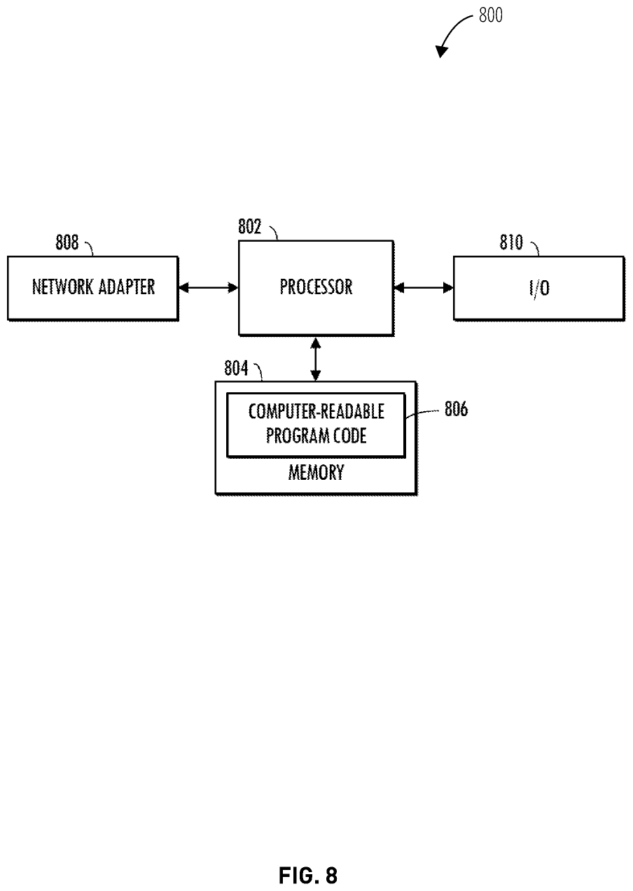

FIG. 8 illustrates the control circuitry 800 according to some example embodiments of the present disclosure. In some examples the control circuit includes some or all of the system controller 106, the indoor controller 124, the outdoor controller 126, and/or controller 226. In some examples, the control circuitry may include one or more of each of a number of components such as, for example, a processor 802 connected to a memory 804. The processor is generally any piece of computer hardware capable of processing information such as, for example, data, computer programs and/or other suitable electronic information. The processor includes one or more electronic circuits some of which may be packaged as an integrated circuit or multiple interconnected integrated circuits (an integrated circuit at times more commonly referred to as a “chip”). The processor 802 may be a number of processors, a multi-core processor or some other type of processor, depending on the particular embodiment.

The processor 802 may be configured to execute computer programs such as computer-readable program code 806, which may be stored onboard the processor or otherwise stored in the memory 804. In some examples, the processor may be embodied as or otherwise include one or more ASICs, FPGAs, or the like. Thus, although the processor may be capable of executing a computer program to perform one or more functions, the processor of various examples may be capable of performing one or more functions without the aid of a computer program.

The memory 804 is generally any piece of computer hardware capable of storing information such as, for example, data, computer-readable program code 806 or other computer programs, and/or other suitable information either on a temporary basis and/or a permanent basis. The memory may include volatile memory such as random-access memory (RAM), and/or non-volatile memory such as a hard drive, flash memory or the like. In various instances, the memory may be referred to as a computer-readable storage medium, which is a non-transitory device capable of storing information. In some examples, then, the computer-readable storage medium is non-transitory and has computer-readable program code stored therein that, in response to execution by the processor 802, causes the control circuitry 216 to perform various operations as described herein, some of which may in turn cause the HVAC system to perform various operations.

In addition to the memory 804, the processor 802 may also be connected to one or more peripherals such as a network adapter 808, one or more input/output (I/O) devices 810 or the like. For example, I/O devices 810 may include an analog to digital converter for converting analog output of the temperature sensors into digital input for a controller. The network adapter is a hardware component configured to connect the control circuitry 800 to a computer network to enable the control circuitry to transmit and/or receive information via the computer network. The I/O devices may include one or more input devices capable of receiving data or instructions for the control circuitry, and/or one or more output devices capable of providing an output from the control circuitry. Examples of suitable input devices include a keyboard, keypad or the like, and examples of suitable output devices include a display device such as a one or more light-emitting diodes (LEDs), a LED display, a liquid crystal display (LCD), or the like.

As explained above and reiterated below, the present disclosure includes, without limitation, the following example implementations.

Clause 1. A compressor for a heating, ventilation, and air conditioning (HVAC) unit, the compressor comprising: a housing, the housing having an interior and an exterior; a motor located within the housing; a power terminal feed-through for providing power to the motor, the power terminal feed-through configured to pass an electrical conductor from the exterior of the housing into the interior of the housing, wherein the electrical conductor comprises a portion of an electrical circuit comprising a ground fault circuit interrupter (GFCI); and a leakage current suppressor configured to reduce passage of electrical current into the housing of the compressor via a conductive pathway between the electrical conductor and the housing, wherein the conductive pathway is created, at least in part, by liquid refrigerant within the housing.

Clause 2. The compressor of the clause wherein the leakage current suppressor comprises a liquid barrier applied to the power terminal feed-through, and wherein the conductive pathway is created, at least in part, by a portion of the liquid refrigerant being located between the power terminal feed-through and the housing.

Clause 3. The compressor of any of the clauses wherein the liquid barrier comprises a waterproof electrical insulator.

Clause 4. The compressor of any of the clauses wherein the liquid barrier comprises one or more of a potting material and an injection molded component.

Clause 5. The compressor of any of the clauses comprising a thermal limit switch on the interior of the housing, wherein the leakage current suppressor comprises a liquid barrier applied to the thermal limit switch, and wherein the conductive pathway is created, at least in part, by a portion of the liquid refrigerant being located between the thermal limit switch and the housing.

Clause 6. The compressor of any of the clauses wherein the liquid barrier comprises a coating applied to the thermal limit switch.

Clause 7. The compressor of any of the clauses wherein the coating comprises varnish.

Clause 8. The compressor of any of the clauses wherein the thermal limit switch is wrapped in a nonconductive shield, the nonconductive shield including at least one opening configured to pass the coating through the nonconductive shield during application of the coating to the thermal limit switch.

Clause 9. The compressor of any of the clauses wherein the liquid barrier comprises one or more of a potting material and an injection molded component.

Clause 10. The compressor of any of the clauses wherein the leakage current suppressor comprises a two-pole contactor and the electrical conductor is selectively connectable to an alternating current power source via the two-pole contactor.

Clause 11. The compressor of any of the clauses comprising a heater configured to heat the interior of the housing in response to detection of a threshold temperature difference between a first temperature sensor at the compressor and a second temperature sensor.

Clause 12. The compressor of any of the clauses wherein the heater comprises a secondary winding at a run capacitor of the motor and the heater utilizes a direct current power source.

Clause 13. The compressor of any of the clauses wherein the heater is mounted externally to the housing and the heater utilizes an alternating current power source.

Clause 14. The compressor of any of the clauses wherein the electrical conductor includes a first electrical conductor and a second electrical conductor, the first electrical conductor connected to a first pole of the two-pole contactor and the second electrical conductor connected to a second pole of the two-pole contactor, and wherein the two-pole contactor disconnects the first and second electrical conductors from the alternating current power source in response to detection of the threshold temperature difference between the first temperature sensor at the compressor and the second temperature sensor.

Clause 15. The compressor of any of the clauses wherein the leakage current suppressor is further configured to reduce passage of electrical current into the housing of the compressor to be less than 3.5 milliamps.

Clause 16. A heating, ventilation, and air conditioning (HVAC) system comprising: a refrigerant circuit configured to route a refrigerant fluid, the refrigerant fluid configured to undergo a phase change between a liquid form and a gas form; a compressor operable to circulate the refrigerant fluid through the refrigerant circuit, the compressor having a motor; and an electrical circuit configured to supply power to the compressor, the electrical circuit coupled to a ground fault circuit interrupter (GFCI) operably connected between a power source and the compressor, wherein a leakage current at the compressor is limited such that the electrical circuit supplies current to the compressor below a trip threshold of the GFCI with, at least a portion of, the refrigerant fluid in a liquid form within the compressor.

Clause 17. The HVAC system of any of the clauses, wherein the compressor further comprises: a housing, the housing having an interior and an exterior; a motor located within the housing; a power terminal feed-through for providing power via the electrical circuit to the motor, the power terminal feed-through configured to pass an electrical conductor from the exterior of the housing into the interior of the housing, wherein the electrical conductor comprises a portion of the electrical circuit; and a leakage current suppressor configured to reduce passage of electrical current into the housing of the compressor via a conductive pathway between the electrical conductor and the housing, wherein the conductive pathway is created, at least in part, by liquid refrigerant within the housing.

Clause 18. The HVAC system of any of the clauses, wherein the leakage current suppressor comprises a liquid barrier applied to the power terminal feed-through, and wherein the conductive pathway is created, at least in part, by a portion of the liquid refrigerant being located between the power terminal feed-through and the housing.

Clause 19. The HVAC system of any of the clauses, wherein the liquid barrier comprises a waterproof electrical insulator.

Clause 20. The HVAC system of any of the clauses, wherein the liquid barrier comprises one or more of a potting material and an injection molded component.

Clause 21. The HVAC system of any of the clauses, comprising a thermal limit switch on the interior of the housing, wherein the leakage current suppressor comprises a liquid barrier applied to the thermal limit switch, and wherein the conductive pathway is created, at least in part, by a portion of the liquid refrigerant being located between the thermal limit switch and the housing.

Clause 22. The HVAC system of any of the clauses, wherein the liquid barrier comprises a coating applied to the thermal limit switch.

Clause 23. The HVAC system of any of the clauses, wherein the coating comprises varnish.

Clause 24. The HVAC system of any of the clauses, wherein the thermal limit switch is wrapped in a nonconductive shield, the nonconductive shield including at least one opening configured to pass the coating through the nonconductive shield during application of the coating to the thermal limit switch.

Clause 25. The HVAC system of any of the clauses, wherein the liquid barrier comprises one or more of a potting material and an injection molded component.

Clause 26. The HVAC system of any of the clauses, wherein the leakage current suppressor comprises a two-pole contactor and the electrical conductor is selectively connectable to an alternating current power source via the two-pole contactor.

Clause 27. The HVAC system of any of the clauses, comprising a heater configured to heat the interior of the housing in response to detection of a threshold temperature difference between a first temperature sensor at the compressor and a second temperature sensor.

Clause 28. The HVAC system of any of the clauses, wherein the heater comprises a secondary winding at a run capacitor of the motor and the heater utilizes a direct current power source.

Clause 28. The HVAC system of any of the clauses, wherein the heater comprises a secondary winding at a run capacitor of the motor and the heater utilizes a direct current power source.

Clause 29. The HVAC system of any of the clauses wherein the heater is mounted externally to the housing and the heater utilizes an alternating current power source.

Clause 30. The HVAC system of any of the clauses, wherein the electrical conductor includes a first electrical conductor and a second electrical conductor, the first electrical conductor connected to a first pole of the two-pole contactor and the second electrical conductor connected to a second pole of the two-pole contactor, and wherein the two-pole contactor disconnects the first and second electrical conductors from the alternating current power source in response to detection of the threshold temperature difference between the compressor and the second temperature sensor.

Clause 31. The HVAC system of any of the clauses, wherein the leakage current suppressor is further configured to reduce passage of electrical current into the housing of the compressor to be less than 3.5 milliamps.

Clause 32. A method comprising: monitoring a proximate temperature; monitoring a remote temperature; detecting a first threshold temperature difference between the proximate temperature and the remote temperature; in response to detection of the first threshold temperature difference, disconnecting the compressor from power via a two-pole contactor and turning on a compressor heater; detecting a second threshold temperature difference between the proximate temperature and the remote temperature; and in response to detection of the second threshold temperature difference, reconnecting the compressor to power via the two-pole contactor and turning off the compressor heater.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A compressor for a heating, ventilation, and air conditioning (HVAC) unit, the compressor comprising:
a housing, the housing having an interior and an exterior;
a motor located within the housing;
a power terminal feed-through for providing power to the motor, the power terminal feed-through configured to pass an electrical conductor from the exterior of the housing into the interior of the housing, wherein the electrical conductor comprises a portion of an electrical circuit comprising a ground fault circuit interrupter (GFCI); and
a leakage current suppressor configured to reduce passage of electrical current into the housing of the compressor via a conductive pathway between the electrical conductor and the housing, wherein the conductive pathway is created, at least in part, by liquid refrigerant within the housing.

2. The compressor of claim 1, wherein the leakage current suppressor comprises a liquid barrier applied to the power terminal feed-through, and wherein the conductive pathway is created, at least in part, by a portion of the liquid refrigerant being located between the power terminal feed-through and the housing.

3. The compressor of claim 2, wherein the liquid barrier comprises a waterproof electrical insulator.

4. The compressor of claim 2, wherein the liquid barrier comprises one or more of a potting material and an injection molded component.

5. The compressor of claim 1, comprising a thermal limit switch on the interior of the housing, wherein the leakage current suppressor comprises a liquid barrier applied to the thermal limit switch, and wherein the conductive pathway is created, at least in part, by a portion of the liquid refrigerant being located between the thermal limit switch and the housing.

6. The compressor of claim 5, wherein the liquid barrier comprises a coating applied to the thermal limit switch.

7. The compressor of claim 6, wherein the coating comprises varnish.

8. The compressor of claim 6, wherein the thermal limit switch is wrapped in a nonconductive shield, the nonconductive shield including at least one opening configured to pass the coating through the nonconductive shield during application of the coating to the thermal limit switch.

9. The compressor of claim 5, wherein the liquid barrier comprises one or more of a potting material and an injection molded component.

10. The compressor of claim 1, wherein the leakage current suppressor comprises a two-pole contactor and the electrical conductor is selectively connectable to an alternating current power source via the two-pole contactor.

11. The compressor of claim 10, comprising a heater configured to heat the interior of the housing in response to detection of a threshold temperature difference between a first temperature sensor at the compressor and a second temperature sensor.

12. The compressor of claim 11, wherein the heater comprises a secondary winding at a run capacitor of the motor and the heater utilizes a direct current power source.

13. The compressor of claim 11, wherein the heater is mounted externally to the housing.

14. The compressor of claim 11, wherein the electrical conductor includes a first electrical conductor and a second electrical conductor, the first electrical conductor connected to a first pole of the two-pole contactor and the second electrical conductor connected to a second pole of the two-pole contactor, and wherein the two-pole contactor disconnects the first and second electrical conductors from the alternating current power source in response to detection of the threshold temperature difference between the first temperature sensor at the compressor and the second temperature sensor.

15. The compressor of claim 1, wherein the leakage current suppressor is further configured to reduce passage of electrical current into the housing of the compressor to be less than 3.5 milliamps.

16. A heating, ventilation, and air conditioning (HVAC) system comprising:
a refrigerant circuit configured to route a refrigerant fluid, the refrigerant fluid configured to undergo a phase change between a liquid state and a gas state;
a compressor operable to circulate the refrigerant fluid through the refrigerant circuit, the compressor having a motor; and
an electrical circuit configured to supply power to the compressor, the electrical circuit coupled to a ground fault circuit interrupter (GFCI) operably connected between a power source and the compressor,
wherein a leakage current at the compressor is limited such that the electrical circuit supplies current to the compressor below a trip threshold of the GFCI with, at least a portion of, the refrigerant fluid in a liquid form within the compressor.

17. The HVAC system of claim 15, wherein the compressor further comprises:
a housing, the housing having an interior and an exterior;
a motor located within the housing;
a power terminal feed-through for providing power via the electrical circuit to the motor, the power terminal feed-through configured to pass an electrical conductor from the exterior of the housing into the interior of the housing, wherein the electrical conductor comprises a portion of the electrical circuit; and
a leakage current suppressor configured to reduce passage of electrical current into the housing of the compressor via a conductive pathway between the electrical conductor and the housing, wherein the conductive pathway is created, at least in part, by liquid refrigerant within the housing.

18. The HVAC system of claim 17, wherein the leakage current suppressor comprises a liquid barrier applied to the power terminal feed-through, and wherein the conductive pathway is created, at least in part, by a portion of the liquid refrigerant being located between the power terminal feed-through and the housing.

19. The HVAC system of claim 18, wherein the liquid barrier comprises a waterproof electrical insulator.

20. The HVAC system of claim 18, wherein the liquid barrier comprises one or more of a potting material and an injection molded component.

21. The HVAC system of claim 17, comprising a thermal limit switch on the interior of the housing, wherein the leakage current suppressor comprises a liquid barrier applied to the thermal limit switch, and wherein the conductive pathway is created, at least in part, by a portion of the liquid refrigerant being located between the thermal limit switch and the housing.

22. The HVAC system of claim 21, wherein the liquid barrier comprises a coating applied to the thermal limit switch.

23. The HVAC system of claim 22, wherein the coating comprises varnish.

24. The HVAC system of claim 22, wherein the thermal limit switch is wrapped in a nonconductive shield, the nonconductive shield including at least one opening configured to pass the coating through the nonconductive shield during application of the coating to the thermal limit switch.

25. The HVAC system of claim 21, wherein the liquid barrier comprises one or more of a potting material and an injection molded component.

26. The HVAC system of claim 17, wherein the leakage current suppressor comprises a two-pole contactor and the electrical conductor is selectively connectable to an alternating current power source via the two-pole contactor.

27. The HVAC system of claim 26, comprising a heater configured to heat the interior of the housing in response to detection of a threshold temperature difference between a first temperature sensor at the compressor and a second temperature sensor.

28. The HVAC system of claim 26, wherein the heater comprises a secondary winding at a run capacitor of the motor and the heater utilizes a direct current power source.

29. The HVAC system of claim 26, wherein the electrical conductor includes a first electrical conductor and a second electrical conductor, the first electrical conductor connected to a first pole of the two-pole contactor and the second electrical conductor connected to a second pole of the two-pole contactor, and wherein the two-pole contactor disconnects the first and second electrical conductors from the alternating current power source in response to detection of the threshold temperature difference between the first temperature sensor at the compressor and the second temperature sensor.

30. The HVAC system of claim 16, wherein the leakage current suppressor is further configured to reduce passage of electrical current into the housing of the compressor to be less than 3.5 milliamps.
